(19) United States
(12) Patent Application Publication
(10) Pub. No.: US 2019/0089120 A1
(43) Pub. Date: Mar. 21, 2019

(54) SOLID-STATE LASER SYSTEMS

(71) Applicant: COMPOUND PHOTONICS LIMITED, London (GB)

(72) Inventor: Akheelesh K. Abeeluck, Phoenix, AZ (US)

(73) Assignee: COMPOUND PHOTONICS LIMITED, London, OT (GB)

(21) Appl. No.: 16/304,261

(22) PCT Filed: May 26, 2017
(86) PCT No.: PCT/US17/34869

§ 371 Date: Nov. 23, 2018

Related U.S. Application Data
(60) Provisional application No. 62/341,622, filed on May 26, 2016.
(60) Provisional application No. 62/342,841, filed on May 27, 2016.

(51) Int. Cl. H01S 3/109; H01S 3/16; H01S 3/06; H01S 3/0941

(52) U.S. Cl. CPC H01S 3/109; H01S 3/1631; H01S 3/042; H01S 3/0617; H01S 3/0941; H01S 3/1618

(57) ABSTRACT

A laser includes a laser pump source (14), a pump-beam coupler (18) coupled with the laser pump source, a laser gain medium (12) comprising Yb:CALGO, a second-harmonic generator (30) and an output coupler (32). The SHG may include a chirped PPLN or PPLT. The laser gainmedium (50) may comprise a gradient doping or plural segments (52-56) with different doping concentration.

### CROSS-REFERENCE TO RELATED APPLICATIONS

The present application claims priority to U.S. Provisional Patent Application No. 62/341,622, filed May 26, 2016, entitled “BROADBAND DIODE-PUMPED SOLID-STATE LASER,” and U.S. Provisional Patent Application No. 62/342,841, filed May 27, 2016, entitled “BROADBAND DIODE-PUMPED SOLID-STATE LASER,” the disclosures of which are hereby incorporated by reference in their entirety for all purposes except for those sections, if any, that are inconsistent with this specification.

### FIELD OF THE INVENTION

The present invention relates to lasers. More particularly, the present invention relates to pumped solid state laser systems and methods.

### BACKGROUND OF THE INVENTION

Diode pumped solid state lasers are known, and involve utilizing a laser diode to pump light into a solid state laser gain medium. The solid state laser gain medium is a crystal material that is doped with one or more laser active species. Solid state lasers are commonly utilized in projector systems, and such projector systems experience speckling in images due to properties associated with the solid state lasers.

### SUMMARY OF THE INVENTION

In an embodiment of the present invention, a broadband diode-pumped solid-state laser (DPSSL) system and/or device is disclosed that may output high-power green laser light between and including approximately 3 W and 12 W at a high electrical-to-optical efficiency between and including approximately 15% and 25%, and have a center wavelength between and including approximately 520 nm and 545 nm, and have a broad spectral bandwidth between and including approximately 5 nm and 30 nm. In an embodiment of the present invention, a diode-pumped solid-state laser system and/or device, in accordance with the present invention, may be operated in a continuous-wave, quasi-continuous-wave mode and/or pulsed mode. All references to bandwidth refer to full width at half maximum (FWHM) bandwidth definition and measurements.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1A illustrates a solid state laser system and/or device in accordance with the present invention.

FIG. 1B illustrates a solid state laser system and/or device in accordance with the present invention.

FIG. 2A illustrates beam shaping elements in accordance with the present invention.

FIG. 2B illustrates a beam shaping device and/or a pump beam coupler in accordance with the present invention.

FIG. 3 illustrates a solid state laser system and/or device in accordance with the present invention

FIG. 4 illustrates a segmented laser medium in accordance with the present invention.

FIG. 5 illustrates a grazing incidence laser medium in accordance with the present invention.

FIG. 6 illustrates metallized layers in accordance with the present invention.

FIG. 7A illustrates a periodically poled nonlinear optical device in accordance with the present invention.

FIG. 7B illustrates a periodically poled nonlinear optical device in accordance with the present invention.

FIG. 8 illustrates a method of lasing in accordance with the present invention.

### DETAILED DESCRIPTION OF THE DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B,” “A or B,” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

In embodiments of the present invention, references to positions of components in a laser system and/or device 10a,10b refer to optical path positions.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

Embodiments of the present invention deliver high power (e.g., between and including approximately 3 W and 12 W) frequency-doubled light within a broad spectral bandwidth (e.g., between and including approximately 5 nm and 30 nm). A laser output at approximately 532 nm center wavelength and spectral bandwidth approximately ≥5 nm has a short coherence length (for example, a coherence length less than approximately 0.02 mm), which may reduce the speckle phenomenon below the perception of the human eye. Thus, the present invention is advantageous for applications such as laser-based despeckled projection systems. Other applications for a broadband laser system and/or device, in accordance with the present invention, include, but are not limited to, visible optical coherence tomography, spectroscopy, biomedical analysis, chemical sensing, and/or holography.

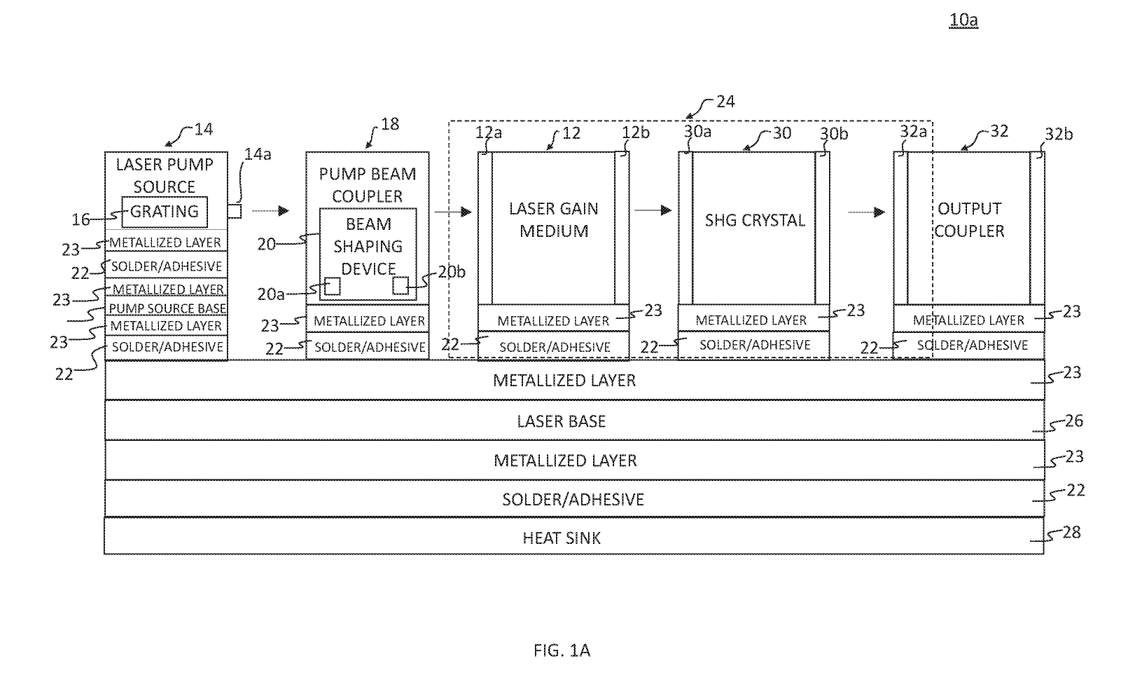

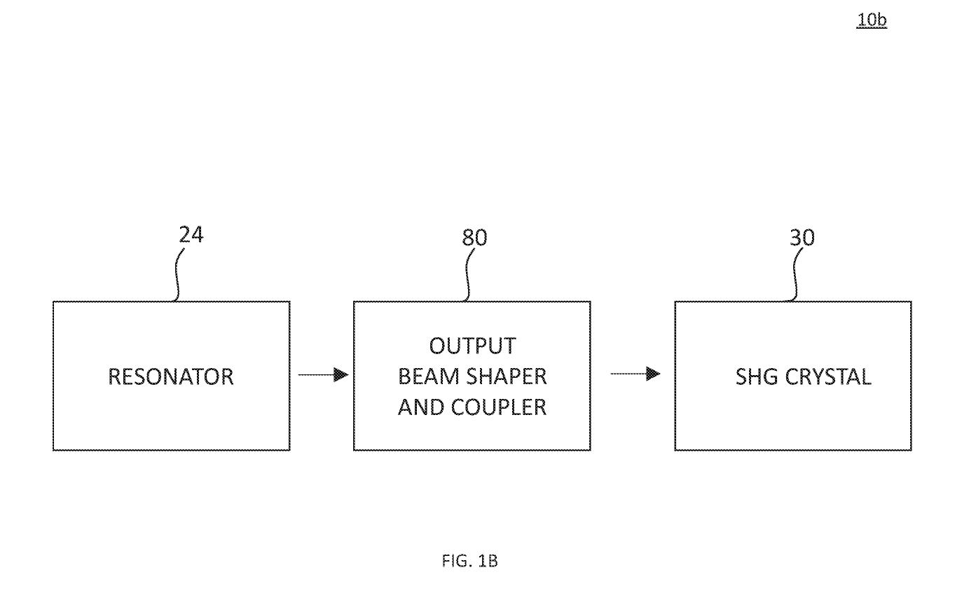

Shown in FIG. 1A is a laser device and/or system 10a in accordance with the present invention. A laser system and/or device 10a, in accordance with the present invention, includes a laser medium 12. In an embodiment of the present invention, the laser medium 12 is a laser gain medium. In an embodiment of the present invention, a nonlinear optical device 30 may be internal to the resonator 24 (i.e., the laser cavity of a laser system and/or device 10a in accordance with the present invention), as shown in FIG. 1A. In an embodiment of the present invention, a nonlinear optical device 30 may be external to the resonator 24 (i.e., the laser cavity of a laser system and/or device 10b in accordance with the present invention), as shown in FIG. 1B. In an embodiment of the present invention, the laser medium 12 is pumped with a pump source 14 that generates electromagnetic radiation (e.g., light). Embodiments herein are described with reference to light for exemplary purposes. However, in all instances, the term “light” may be replaced with “electromagnetic radiation.” In an embodiment of the present invention, the pump source 14 is a laser pump source, for example, a laser diode. In an embodiment of the present invention, the pump source 14 may include one or more emitters 14a. In an embodiment of the present invention, the pump source 14 is a laser diode bar pump source, for example, a laser diode bar. In an embodiment of the present invention, the pump source 14 may be a fiber-coupled pump source, for example, a fiber coupled laser diode. It would be understood by one of ordinary skill in the art that other types of pump sources may be utilized, for example multi-bar pump sources (for example, at least two laser bars arranged in a bar and/or stack). In an embodiment of the present invention, a pump source 14 is a laser diode bar pump source 14 having 19 single emitters with an emitter stripe width of approximately 100 microns and an emitter pitch of approximately 500 microns. In an embodiment of the present invention, a pump source 14 is a laser diode bar having a number of single emitters in the range of, for example, approximately between and including 5 and 24, an emitter stripe width in the range of for example, approximately and including 50 microns to 200 microns, and/or an having an emitter pitch in the range of, for example, approximately and including 150 microns to 600 microns. For example, in an embodiment of the present invention, the pump source 14 has a wavelength of 980 nm or approximately 980 nm (e.g., 979.1 nm). In an embodiment of the present invention, the pump source 14 (e.g., a laser diode bar) may have a center wavelength in the range between and including 900 nm and 1000 nm. In an embodiment of the present invention, the pump source 14 sits on a pump source base 14b, made from a thermally conductive material (e.g., BeO, CuW, oxygen-free copper, sapphire and/or diamond). A pump source 14, in accordance with the present invention, may be coupled to the pump source base 14b, for example, via an attachment layer 22. In an embodiment of the present invention, an attachment layer 22 is made from a bonding substance, for example, an adhesive and/or metallic connection (e.g., solder). In an embodiment of the present invention, when the pump source 14 is coupled to the pump source base 14b via a metallic connection, the pump source 14 has a metallized layer 23 that is soldered to the pump source base 14b. For example, in an embodiment of the present invention, the pump source base 14b is made from oxygen-free copper 110 and is a CS type of mount. In an embodiment of the present invention, a pump source base 14 is coupled to a laser base 26 via an attachment layer 22 and/or metallized layer 23.

In an embodiment of the present invention, the pump source 14 is laser diode bar that may have a spectral shift with temperature in the range of between and approximately 0.3 nm/degree Celsius and 0.4 nm/degree Celsius. In an embodiment of the present invention, the pump source 14 is laser diode bar that may have a spectral bandwidth in the range of between and approximately 2 nm and 4 nm. In an embodiment of the present invention, the pump source 14 is laser diode bar that has a spectral shift with temperature of approximately 0.35 nm/degree Celsius and a spectral bandwidth of 3 nm. A broadband laser gain medium 12, in accordance with the present invention may have a broad absorption bandwidth (e.g., in a range between and including approximately 5 nm and 10 nm). For example, in an embodiment of the present invention, the laser medium 12 is a Yb:CALGO material that has a FWHM absorption bandwidth of approximately 8.8 nm that is wide enough for absorption of the pump light from the pump source 14.

In an embodiment of the present invention, the pump source 14 (e.g., a laser diode) may be a wavelength-stabilized device (e.g., a frequency locked device) having a center wavelength in the range between and including 965 nm and 990 nm. In an embodiment of the present invention, the pump source 14 may have a wavelength that is stabilized at 980 nm or approximately 980 nm (e.g., 979.1 nm).

In embodiments of the present invention, a wavelength of the pump source 14, for example, a laser diode, is stabilized by incorporating, including, integrating, coupling, and/or placing an internal grating 16 in a cavity of the pump source 14 (e.g., a laser diode). By wavelength-stabilizing the pump source 14, for example, a laser diode, spectral shift of the light output from the pump source 14 with temperature is small (e.g., between and including approximately 0.05 nm per degree Celsius and 0.07 nm per degree Celsius), and provides, for example, more flexibility in thermal management of the pump source. In an embodiment of the present invention, a pump source 14, in accordance with the present invention has a narrow spectral bandwidth (e.g., a bandwidth between and including approximately 0.1 nm and 0.5 nm) and provides, for example, high absorption in the laser medium 12 when the peak of the pump source 14 spectrum is close to the peak of the absorption spectrum of the laser medium 12.

In an embodiment of the present invention, a pump source 14 (e.g., a laser diode), in accordance with the present invention, outputs a power in the range between and including approximately 10 W and 100 W. For example, in an embodiment of the present invention, the pump source 14, in accordance with the present invention, has an output power of approximately 40 W. In an embodiment of the present invention, a pump source 14 has a high power-conversion efficiency, for example, in the range between and including approximately 60% and 75% and, consequently, improves thermal management of the overall laser device and/or system 10a,10b. For example, in an embodiment of the present invention, the pump source 14, in accordance with the present invention, has a power-conversion efficiency of approximately 70%.

In an embodiment of the present invention, the dimensions of a pump source 14, in accordance with the present invention is, for example, approximately 25 mm in width, approximately 25 mm in length and approximately 8 mm in height, and such dimensions and/or approximate dimensions achieve a laser system/device 10a,10b, in accordance with the present invention, that is compact in size. In embodiments of the present invention, the width of a pump source 14, in accordance with the present invention, may be in the range of approximately between and including 20 mm and 30 mm, the length may be in the range of approximately between and including 20 mm and 30 mm, and the height may be in the range of approximately between and including 6 mm and 10 mm.

In an embodiment of a laser system and/or device 10a,10b, in accordance with the present invention, a pump beam coupler (PBC) 18 may be utilized to shape and/or couple an output (e.g., an optical output) from the pump source 14 to a laser medium 12. For example, in an embodiment of a laser system and/or device 10a,10b, in accordance with the present invention, a pump beam coupler 18 is utilized to optically shape and couple the output from the pump source 14.

In an embodiment of the present invention, the pump beam coupler 18 includes a beam shaping device 20. A beam shaping device 20, in accordance with the present invention, may include one or more refractive optical elements (for example, lenses) and/or diffractive optical elements 20a,20b. For example, in an embodiment of the present invention, the beam shaping device 20a is a plano-convex cylindrical lens that may be utilized to shape and/or couple the pump beam from the pump source 14 to the laser gain medium 12 along the fast-axis of the pump source. For example, in an embodiment of the present invention, the beam shaping device 20b is a plano-convex cylindrical lens that may be utilized to shape and/or couple the pump beam from the pump source 14 to the laser gain medium 12 along the slow-axis of the pump source 14.

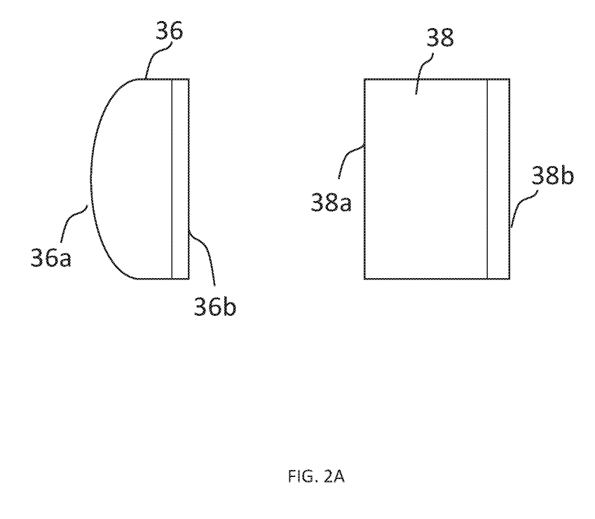

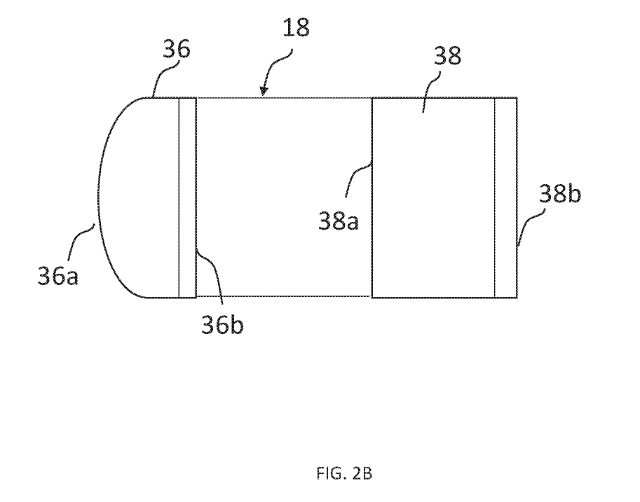

An embodiment of the present invention, as shown in FIG. 2A, may include fast axis and slow axis beam shaping elements (e.g., collimators). As shown in FIG. 2A, beam shaping element 36 is a fast-axis collimation and slow-axis collimation lens module (e.g., FAC-SAC collimation module), for example, a commercial device from LIMO Lissotschenko Mikrooptik GmbH (product number MOD000631) that collimates the pump beam from the pump source 14 along both the fast and slow axes. The commercial FAC-SAC collimation module has approximate dimensions of 11.5 mm×3.71 mm×1.5 mm from the vendor's datasheet. In embodiments of the present invention, a small size of a beam shaping element 36, in accordance with the present invention, contributes to the compact size of the laser device and/or system 10a,10b. Using a single FAC-SAC collimation module to collimate the pump beam from the pump source 14 (as opposed to two or more pump beam shaping elements and/or coupling elements for pump beam collimation) along the fast and slow axes reduces the number of interfaces the pump beam passes through when traveling from the pump source 14 to the laser medium 12 and therefore reduces transmission loss of the pump beam. In an embodiment of the present invention, a beam shaping device 38, for example, a cylindrical lens of focal length in the range between and including approximately 1 mm and 30 mm, is used to shape and/or further shape the pump beam along the slow axis and couple the beam into the laser medium 12. In an embodiment of the present invention, a cylindrical lens 38 has a focal length of approximately 12.7 mm. In an embodiment of the present invention, a cylindrical lens 38 has approximate dimensions of 12.7 mm×6.4 mm×3 mm. In an embodiment of the present invention, a cylindrical lens 38 may have a length in the range of between and including 10 mm and 14 mm, a width in the range of between and including 5 mm and 7 mm, and a height in the range of between and including 2 mm and 4 mm. In an embodiment of the present invention, the pump beam coupler 18 corresponds to or is the beam shaping device 20. For example, in an embodiment of the present invention, the pump beam coupler 18 corresponds to the beam shaping device 20. In an embodiment of the present invention, the first and second surfaces 36a and 36b of the FAC-SAC collimation lens module 36 and the first and second surfaces 38a and 38b of the cylindrical lens 38 are coated with anti-reflective (AR) coatings to minimize transmission loss of the pump beam from the pump source 14 through the pump beam coupler 18 and/or beam shaping device 20. In embodiments of the present invention, the pump beam coupler 18 and/or beam shaping device 20 may be coupled to, integrated into, or incorporated in the pump source 14. Shown in FIG. 2B, is a pump beam coupler 18 that includes two beam shaping elements 36,38, which in an embodiment of the present invention, are coupled together.

In embodiments of the present invention, the coatings may include one or more same materials, different materials and/or combination of materials, for example, dielectric materials. In embodiments of the present invention, the coatings may include tantalum (Ta), silicon (Si), titanium (Ti), hafnium (Hf). In embodiments of the present invention, the materials may include at least one or more oxidized versions of Ta, Si, Ti, Hf. In embodiments of the present invention, the coatings forming the AR surfaces on the first and second surfaces (i.e., optical facets) of the pump beam shaping elements 20a,20b,36,38 of the pump coupler 18 may include, for example, dielectric stacks (e.g., alternating layers) of Ta₂O₅ and SiO₂, TiO₂ and SiO₂, and/or HfO₂ and SiO₂. For example, in an embodiment of the present invention, the pump beam coupler 18 beam shaping device 20, and/or beam shaping elements 20a, 20b, 36,38 may have AR coatings on at least one of the optical facets/surfaces (e.g., on all of the surfaces/optical facets) and couple 980 nm light from the pump source 14 to the laser gain medium 12 with low transmission loss (e.g., less than 0.5%) via utilization of, for example, Ta₂O₅ and SiO₂ dielectric stacks.

In an embodiment of the present invention, a laser system and/or device 10a, 10b, in accordance with the present invention, includes a laser medium 12. In an embodiment of the present invention, the laser medium 12 is included in a laser resonator 24 in accordance with the present invention. References to intracavity wavelengths refer to wavelengths inside of the laser resonator 24. In an embodiment of the present invention, the laser resonator 24 may include a nonlinear optical device 30 and/or a first surface 32a of an output coupler 32. In an embodiment of a laser system and/or device 10a, in accordance with the present invention, the nonlinear optical device 30 is a frequency doubling device (e.g., a second harmonic generator (SHG) material and/or crystal).

In an embodiment of the present invention, a nonlinear optical device 30 may be external to the resonator 24 (i.e., the laser cavity of a laser system and/or device 10b in accordance with the present invention), as shown in FIG. 1B. In this embodiment, the resonator 24 may be optimized to output high-power broadband IR light (e.g., in the range between approximately and including 1 W and 35 W) that may be shaped and coupled using an output beam shaper and coupler 80 to the nonlinear optical device 30 for generation of broadband frequency-doubled light. In an embodiment of the present invention, the output beam shaper and coupler 80 may include one or more refractive and/or diffractive optical elements.

In an embodiment of the present invention, laser medium 12 has a first surface 12a and a second surface 12b. The first surface 12a receives light output from a pump source 14, for example, via a pump beam coupler 18. In an embodiment of the present invention, the laser medium 12 may receive light directly from the pump source 14. The second surface 12b is on a side of the laser medium 12 where light is outputted or emitted from the laser medium 12 (e.g., infrared (IR) light). In an embodiment of the present invention, the light emitted from the laser medium 12 is outputted, for example, to a nonlinear optical device 30. In an embodiment of the present invention, when the nonlinear optical device 30 is external to the laser resonator 24, the light emitted from the laser medium 12 may be received directly by the output coupler 32 and, in this embodiment of the present invention, the output coupler 32 may then output light that is received by the nonlinear optical device 30.

In an embodiment of a laser medium 12, in accordance with the present invention, a first surface 12a of the laser medium 12 may be an anti-reflector (AR) at the pump source 14 (e.g., laser diode) pump wavelength and a high reflector (HR) at the intracavity broadband infrared (IR) lasing wavelength. In an embodiment of a laser medium 12, in accordance with the present invention, a second surface 12b may be an AR at the intracavity broadband IR lasing wavelength (i.e., intra resonator IR lasing wavelength), and an HR or AR at the pump wavelength.

For example, in an embodiment of the present invention, a laser medium 12 has a first surface 12a that is an AR at the pump source 14 wavelength and an HR at the intracavity broadband IR lasing wavelength, and has a second surface 12b that is an AR at the intracavity broadband IR wavelength and an HR at the pump source 14 wavelength, thereby achieving double-passing of the pump beam in the laser medium 12, and enhancing pump absorption efficiency. Double-passing of the pump beam in the laser medium 12 enables a reduced in size laser medium 12 and and/or achieves a laser system and/or device 10a,10b that is compact in size.

In embodiments of the present invention, the first and second surfaces (e.g., optical facets) 12a,12b of the laser medium 12 are coated with one or more materials and/or material systems. In embodiments of the present invention, the reflectivity and/or transmissivity of the coating materials and/or material systems of the first and second surfaces 12a,12b correspond to coating materials and/or material systems that reflect and/or transmit the wavelength of light (1) generated in the resonator 24 and/or (2) received and/or outputted external to the resonator 24. In an embodiment of the present invention, a coating may serve more than one purpose (e.g., dual purposes), for example, the coating may be an anti-reflector (AR) coating for one wavelength and an AR for another wavelength, an AR for one wavelength and a high reflector (HR) for another wavelength, or an HR for one wavelength and an HR for another wavelength.

In an embodiment of the present invention, a laser medium 12 (e.g., a broadband laser gain medium), in accordance with the present invention, has a broadband fluorescence spectrum, for example, a spectrum of approximately 80 nm bandwidth. For example, in an embodiment of the present invention, the laser medium 12 is Yb:CALGO that has a fluorescence spectrum of approximately 80 nm bandwidth. A broadband laser gain medium 12, in accordance with the present invention, may also have a non-negligible absorption spectral bandwidth (e.g., Yb:CALGO has an absorption spectrum peaking at approximately 980 nm and has a FWHM bandwidth of approximately 9 nm). In an embodiment of the present invention, the wavelength-dependent small-signal IR laser gain of the laser medium 12 needs to be larger than the wavelength-dependent resonator 24 loss across the desired broadband IR lasing spectrum (e.g., approximately 1040-1090 nm) to achieve a desired broadband frequency-doubled spectrum (e.g., approximately 520-545 nm). Wavelength-dependent losses inside the resonator 24 may include wavelength-dependent absorption and/or scattering in the laser medium 12, nonlinear optical device 30 and/or output coupler 32, and/or reflection losses at the coatings of the laser resonator components. In an embodiment of the present invention, the wavelength-dependent reflectivity of one or more coatings of the laser resonator components can be designed for a constant or near constant difference between the small-signal IR laser gain of the laser medium 12 and the resonator 24 loss (including conversion of the IR light into frequency doubled light in the nonlinear optical device 30) across the desired broadband IR lasing spectrum to achieve a desired broadband frequency-doubled spectrum. For example, in a laser system and/or device 10a,10b, in accordance with the present invention, a net gain of the laser gain medium 12 is constant or nearly constant across the lasing IR bandwidth.

In embodiments of the present invention, the coatings on the first and second surfaces of the laser medium 12 may include one or more same materials, different materials, and/or combination of materials, for example, dielectric materials. In embodiments of the present invention, the coatings on the first and second surfaces of the laser medium 12 may include tantalum (Ta), silicon (Si), titanium (Ti), hafnium (Hf). In embodiments of the present invention, the materials may include at least one or more oxidized versions of Ta, Si, Ti, Hf. In embodiments of the present invention, the coatings may include, for example, dielectric stacks (e.g., alternating layers) of Ta₂O₅ and SiO₂, TiO₂ and SiO₂, and/or HfO₂ and SiO₂. In embodiments of the present invention, the laser medium 12 achieves an intracavity broadband IR wavelength of 1040-1090 nm or approximately 1040-1090 nm via utilization of, for example, a Ta₂O₅ and SiO₂ dielectric stack as AR (at 980 nm)/HR (at 1040-1090 nm) for the first surface 12a and a Ta₂O₅ and SiO₂dielectric stack as AR (at 1040-1090 nm)/HR (at 980 nm) for the second surface 12b.

The length selections and doping levels of embodiments of a laser medium 12, in accordance with the present invention, achieve thermal management of the laser medium 12, prevent thermal roll-over of a laser device and/or system 10a,10b, and/or enable high-power operation of the laser device and/or system 10a,10b. The length of the laser medium 12 and uniform or near-uniform doping level of the laser medium 12 distributes the pump light absorption uniformly or near uniformly throughout the laser medium 12. Consequently, the heat load of the laser medium 12 may be distributed uniformly or near uniformly throughout the laser medium 12, the peak temperature of the laser medium 12 may be reduced, and/or thermal lensing in the laser medium 12, which could cause a resonator to become unstable, is mitigated.

In embodiments of the present invention, the laser medium 12 may be a broadband laser gain medium (e.g., a laser gain medium that has a fluorescence bandwidth in the range of approximately between and including 5 nm and 100 nm). In an embodiment of the present invention, the laser gain medium may be a Yb:CALGO crystal that has a wide fluorescence bandwidth of approximately 80 nm. In an embodiment of the present invention, the laser medium 12 may include a Yb:CALGO crystal having a length between and including approximately 1 mm and 15 mm, with a uniform or near uniform Yb³⁺ doping level between and including approximately 0.2 at. % and 10 at. %. In an embodiment of the present invention, the Yb:CALGO crystal length is sized to approximately 5 mm, with a uniform or near uniform Yb³⁺ doping level of approximately 3 at. %. In an embodiment of the present invention, the laser medium 12 may include, for example, Yb:YAG, Nd:CALGO, Yb:KYW and/or Yb:YVO₄ crystals. In an embodiment of the present invention, the doping level of the laser medium 12 and/or the length of the laser medium 12 achieves a laser medium 12 that is compact in size and, consequently, provides a laser medium 12 and/or laser system and/or device 10a,10b, in accordance with the present invention, that is compact.

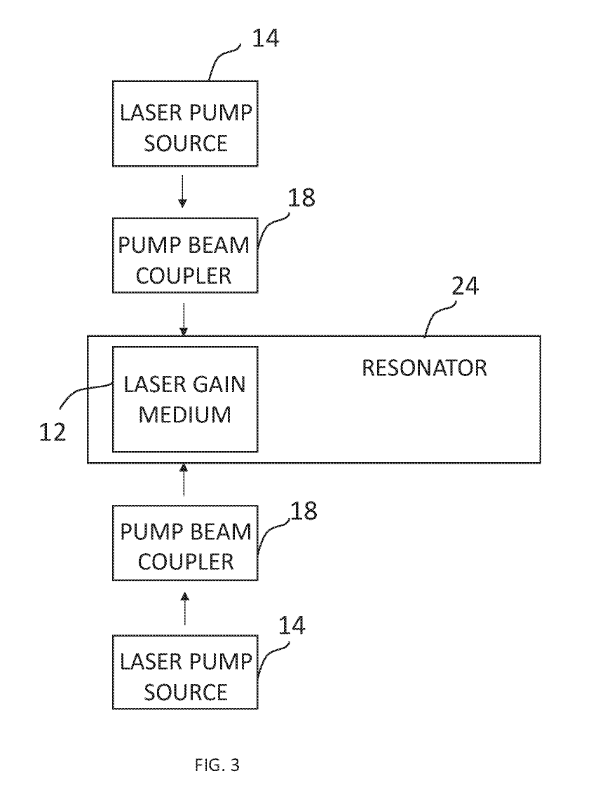

In an embodiment of the present invention, a laser medium 12, in accordance with the present invention, may be designed to enhance thermal management of the laser system and/or device 10a,10b. For example, in an embodiment of the present invention, the laser medium 12 may have a gradient doping along its length. For example, the laser medium 12 may have a low dopant concentration at the pump entrance face of the laser medium 12, for example, a dopant concentration in the range of between and including approximately 0.1 at. % and 1.0 at. %. In an embodiment of the present invention, the dopant concentration may increase gradually toward the center of the crystal to a doping level, for example, to a dopant concentration level between and including approximately 2 at. % and 6 at. %. In an embodiment of the present invention, the dopant concentration may decrease toward the other end of the laser medium 12 to, for example, a dopant concentration level between and including approximately 0.1 at. % and 1.0 at. %. In an embodiment of the present invention, the laser medium 12 having a gradient doping may have an undoped endcap at the pump entrance face of the laser gain medium and/or an undoped endcap at the opposite face of the laser medium 12 to provide additional path for heat dissipation from the laser gain medium, which may enhance the efficiency of the laser system and/or device 10a,10b. In embodiments of a laser medium 12, in accordance with the present invention, gradient doping of a laser gain medium 12 enables pump beam absorption throughout the laser gain medium 12 (e.g., as opposed to absorbing most of the pump beam power close to the pump entrance face of the laser medium 12), and consequently, distributes a heat load evenly throughout the laser gain medium 12, contributes to thermal management of the laser system and/or device 10a,10b and/or improves performance (e.g., output power, efficiency, beam divergence, and/or beam quality) of the laser system and/or device 10a,10b. In an embodiment of the present invention, a laser medium 12 having gradient doping may be end-pumped, as shown in FIG. 1A, with one or more pump sources. In another embodiment of the present invention, the laser gain medium 12 with gradient doping may be side-pumped with one or more pump sources 14 from one or more sides of the laser medium 12, as shown in FIG. 3.

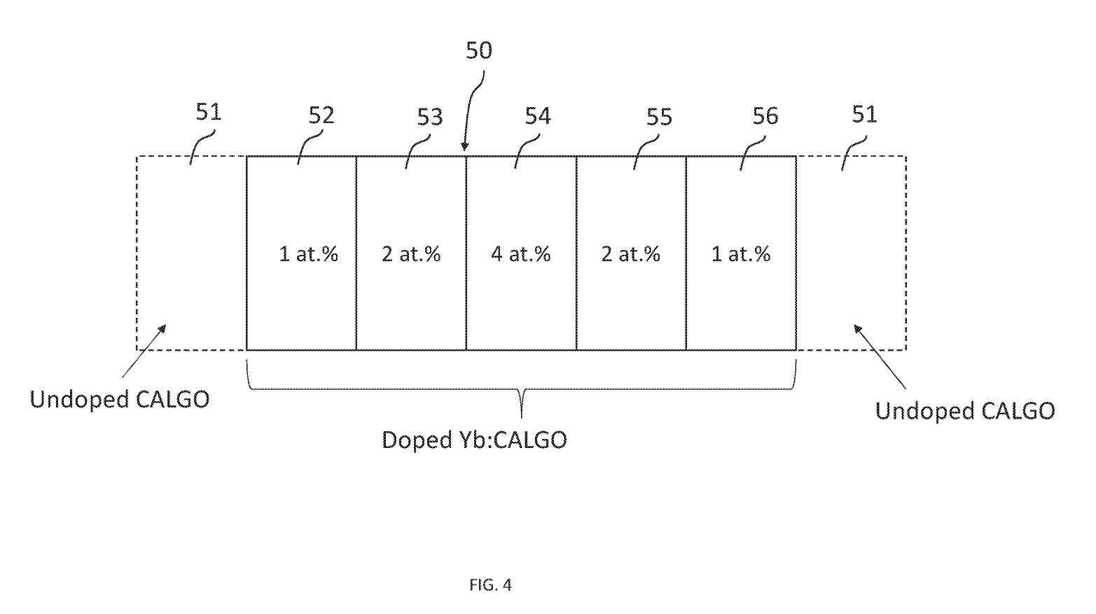

In an embodiment of the present invention, a laser medium 12, in accordance with the present invention may be a segmented laser gain medium 12. It would be understood by one of ordinary skill in the art that the number of segments may vary and/or the doping of the segments may vary. In embodiments of the present invention, a laser medium 12 in accordance with the present invention may have, for example, between and including 3 and 10 segments. For example, in an embodiment of the present invention, a segmented laser gain medium 12 may include materials (e.g., crystals) of different doping levels bonded together. In an embodiment of the present invention, the segments of the laser medium 12 may include the same or different matrix materials (e.g., YAG, CALGO, YVO₄, and/or KYW) and the same or different dopant species (e.g., Yb³⁺, Nd³⁺, and/or Er³⁺). In an embodiment of the present invention, the laser medium 12 includes, for example, Yb:CALGO segmented crystals of different dopant levels bonded together. In an embodiment of the present invention, as shown in FIG. 4, a segmented laser gain medium 12 may have an undoped endcap segment 51 at the pump entrance face of the laser medium 12 and/or an undoped endcap segment 51 at the opposite face of the laser medium 12 to provide additional path for heat dissipation from the laser medium 12. In an embodiment of the present invention, the segments may have different lengths and/or doping levels. In embodiments of the present invention, the segments may be bonded, for example, the layers may be bonded by utilizing diffusion bonding, chemically activated direct bonding™ technique by Precision Photonics/Advanced Thin Films, and/or adhesive-free bonding technique by Onyx Optics, Inc.™. In an embodiment of the present invention, the laser medium 12 may be, for example, a segmented medium having 5 segments, as shown in FIG. 4, wherein the doping of a first segment 52 may be 1 at. %, a doping of a second segment 53 may be 2 at. %, a doping of a third segment 54 may be 4 at. %, a doping of a fourth segment 55 may be 2 at. %, and a doping of a fifth segment 56 may be 1 at. %. In embodiments of a laser medium 12, in accordance with the present invention, segmenting a laser gain medium 12, in accordance with the present invention, enables even pump beam absorption throughout the laser medium 12 (e.g., as opposed to absorbing most of the pump beam power close to the pump entrance face of the laser medium 12), and consequently, distributes a heat load throughout the laser medium 12, contributes to thermal management of the laser system and/or device 10a,10b and/or improves performance (e.g., output power, efficiency, beam divergence, and/or beam quality) of the laser system and/or device 10a,10b. In an embodiment of the present invention, the segmented laser gain medium 12 may be end-pumped with one or more pump sources 14, as shown in FIG. 1A. In other embodiments of the present invention, the segmented laser gain medium 12 may be side-pumped, as shown in FIG. 3, with one or more pump sources 14.

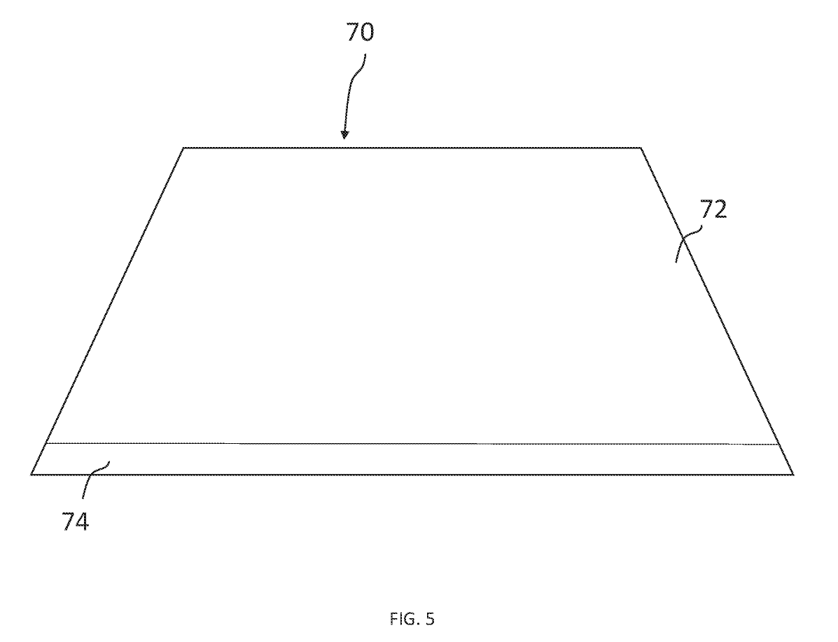

In an embodiment of the present invention, a laser gain medium, in accordance with the present invention, may be a grazing-incidence crystal, as shown in FIG. 5, having at least two layers. In an embodiment of the present invention, a first layer 74 may be, for example, a highly doped thin disk layer (for example, of approximate thickness 0.5 mm and of approximate doping 10 at. %). In an embodiment of the present invention, the highly doped thin disk layer is Yb:CALGO. In an embodiment of the present invention, a second layer 72 may be an undoped layer (e.g., undoped CALGO) bonded to the disk layer. In other embodiments, the thickness of the doped thin disk is between and including approximately 0.1 mm and 0.75 mm, and the doping level is between and including approximately 7.5 at. % to 15 at. %. In an embodiment of the present invention, a doped disk layer may be, for example, Yb:YAG, Yb:YVO₄, Nd:CALGO, and/or Yb:KYW. In an embodiment of the present invention, an undoped layer may be YAG, YVO₄, CALGO, and/or KYW. In embodiments in the present invention, the layers of a grazing incidence medium 12 may be bonded. For example, the layers may be bonded by utilizing such techniques as diffusion bonding, chemically activated direct bonding™ technique by Precision Photonics/Advanced Thin Films, and/or adhesive-free bonding technique by Onyx Optics, Inc.™. In an embodiment of the present invention, the geometry of the grazing incidence laser medium 12, in accordance with the present invention, enables pump beam absorption in a highly doped thin disk layer adjacent to a laser base 26 that is in thermal contact with a heat sink 28. In embodiments of a grazing incidence laser medium 12, in accordance with the present invention, the rate of heat transfer from the crystal is increased due to the small thickness of the doped disk layer and close proximity of the heat generated in the doped disk layer to the laser base (the heat load occurs significantly in the highly doped thin disk layer). Consequently, the close proximity of the heat load to the heat sink contributes to thermal management of the laser system and/or device 10a,10b and/or improves performance (e.g., output power, efficiency, beam divergence, and/or beam quality) of the laser system and/or device 10a,10b. In embodiments of the present invention, the grazing-incidence laser medium 12 may be side-pumped, as shown in FIG. 3, with one or more pump sources 14.

In an embodiment of the present invention, a pump source 14, a pump base 14b, a pump beam coupler 18, a laser medium 12, a nonlinear optical device 30 and/or an output coupler 32 may be attached to, integrated with, and/or coupled to a laser base 26 via an attachment layer 22. In an embodiment of the present invention, the laser base 26 may be made from, for example copper.

In an embodiment of the present invention, components of a laser system and/or device 10a,10b, in accordance with the present invention may be coupled to each other via, for example, bonding and soldering methods. For example, components, in accordance with the present invention may be coupled as follows: (1) a pump beam coupler 18, laser medium 12, nonlinear optical device 30, and/or output coupler 32 may be bonded to a laser base 26; (2) a pump beam coupler 18, laser medium 12, nonlinear optical device 30, and/or output coupler 32 may be soldered to the laser base 26; (3) a laser base 26 may be bonded and/or soldered to heat sink 28; (4) a pump source 14 may be bonded and/or soldered to a pump base 14b; and (5) a pump source 14 (with or without a pump source base 14b) may be bonded and/or soldered to a laser base 26.

In an embodiment of the present invention, components of a laser system and/or device 10a,10b, in accordance with the present invention, may be bonded by utilizing an adhesive, for example, an epoxy and/or thermal grease. In an embodiment of the present invention, the pump beam coupler 18, nonlinear optical device 30, output coupler 32 of the present invention are bonded to a laser base 26 with an epoxy, for example, a UV-curable epoxy. In an embodiment of the present invention, an epoxy is utilized that has low linear shrinkage (e.g., in the range of approximately between and including 0.05% to 1%). In an embodiment of the present invention, an epoxy (e.g., UV-curable epoxy Low Shrink™ OP-61-LS from Dymax Corporation) that has a low shrinkage (e.g., <0.1%) is utilized to bond components of the laser system and/or device 10a,10b, in accordance with the present invention, to each other, for example, to bond the pump beam coupler 18, nonlinear optical device 30 and/or output coupler 32 to the laser base 26. In an embodiment of the present invention, the laser medium 12 and the nonlinear optical device 30 may be bonded to the laser base 26 with a low-outgassing epoxy of high thermal conductivity (e.g., in the range of approximately between and including 1 W/(mK) to 5 W/(mK)), and achieves efficient heat transfer from the laser medium 12 and nonlinear optical device 30 to the laser base 26. For example, in an embodiment of the present invention, a two-part, low-outgassing, thermally conductive silicone (e.g., CV-2946 from Nusil) may be used to bond the laser medium 12 and the nonlinear optical device 30a to the laser base 26.

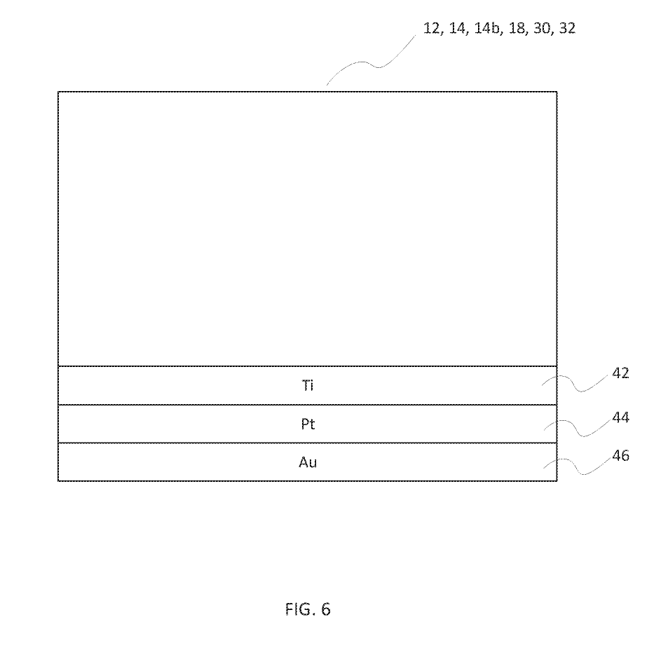

In an embodiment of the present invention, components of a laser system and/or device 10a,10b, in accordance with the present invention, may be bonded by utilizing a solder, for example, AuSn, InSn, In, InAg, and/or SAC solder. In embodiments of the present invention, at least one of two components that are soldered together, for example, of a laser system and/or device 10a,10b, in accordance with the present invention, is metallized before being soldered to another component of a laser system and/or device 10a,10b in accordance with the present invention. In embodiments of the present invention, components of a laser system and/or device 10a,10b are metallized with one or more metals and/or combination of metals, for example, metals or combinations of metals that include Ti, Pt, Au, Cr, and/or Ni. For example, in an embodiment of the present invention, a plurality of metal layers utilized include layers of, for example, Ti, Pt, Au, Cr, and/or Ni. In an embodiment of the present invention, a surface of a component in laser system and/or device 10a,10b, in accordance with the present invention is metallized with at least a first layer of metal, a second layer of metal, and a third layer of metal. In an embodiment of the present invention, as shown in FIG. 6, a surface of a component 12,14, 14b, 18, 30 and/or 32 of a laser system and/or device 10a,10b, in accordance with the present invention, may be metallized with at least one layer of metal 42, 44, 46. In an embodiment of the present invention, a surface of a component of a laser system and/or device 10a,10b, in accordance with the present invention is metallized with at least a layer of Ti, a layer of Pt, and/or a layer of Au. For example, as shown in FIG. 6, a surface of a component of a laser system and/or device 10a,10b, in accordance with the present invention is metallized with at least a layer of Cr, a layer of Ni, and a layer of Au. It would be understood by one of ordinary skill in the art that the number of layers and/or the order of layers may vary. In an embodiment of the present invention, a laser system and/or device 10a,10b has a pump source 14 that is soldered to a Ti/Pt/Au-metallized pump source base 14b using AuSn solder, a Ti/Pt/Au-metallized pump source base 14b is soldered to a laser base 26 using SAC solder, a Ti/Pt/Au-metallized laser medium 12 is soldered to a NiAu-plated laser base 26 using InAg solder, and/or a Ti/Pt/Au-metallized nonlinear optical device 30 is soldered to a NiAu-plated laser base 26 using InSn solder.

In an embodiment of the present invention, heat dissipation from a component of a laser system and/or device 10a,10b is achieved by metallizing a surface of the component of a laser system and/or device 10a,10b with layers of metals, for example, layers of (1) Ti, Pt, and Au or (2) Cr, Ni, and Au or (3) Ni and Au.

In an embodiment of the present invention, the laser base 26 may be bonded and/or soldered to the heat sink 28. In an embodiment of the present invention, the laser base 26 is soldered to the heat sink 28 with a solder, for example, InSn, In and/or SAC solder. In an embodiment of the present invention, the laser base 26 is bonded to the heat sink 28 using a thermally conductive epoxy.

In an embodiment of the present invention, heat transfer between the laser medium 12 and the heat sink 28 is improved when the laser medium 12 height is reduced to, for example, between and including approximately 0.5 mm and 3 mm. In an embodiment of the present invention, the height of the laser medium 12 is reduced to 2 mm.

In a laser system and/or device 10a,10b, in accordance with embodiments of the invention, the dopant concentration of the laser medium 12, and/or the radius of the pump beam received from, for example, the pump beam coupler 18, into the laser medium 12 (e.g., the received pump beam has a radius between and including approximately 50 microns and 300 microns) provides for the pump absorption and the heat load to be distributed more uniformly in the laser medium 12. With more uniform heat distribution in the laser medium 12, the temperature of the laser medium 12 is more uniform, the peak temperature of the laser medium 12 is lower, and thermal lensing, which could occur in the laser medium 12 due to the heat load and cause the resonator to become unstable, is mitigated. A laser system and/or device 10a,10b in accordance with the present invention achieves more uniform heat distribution in the laser medium and provides for more efficient thermal management of the laser medium 12 and/or the laser system and/or device 10a,10b of embodiments of the present invention.

In an embodiment of the present invention, laser system and/or device 10a,10b, in accordance with the present invention may include a nonlinear optical device 30 (e.g., a frequency doubling device) that is internal or external to the laser resonator 24 and that generates an output based on one or more nonlinear optical processes (e.g., frequency doubling and/or sum-frequency generation processes). In an embodiment of the present invention, the nonlinear optical device 30 is a frequency doubling device, for example, a second-harmonic generating (SHG) crystal.

In an embodiment of the present invention, the first and second surfaces 30a,30b of the nonlinear optical device 30 are coated with one or more materials and/or material systems that are tailored to reflect and/or transmit wavelength of light generated either in the resonator 24 or external to the resonator 24. In an embodiment of the present invention a coating for the nonlinear optical device 30 may serve more than one purpose (e.g., dual purposes), for example, the coating may be an anti-reflector (AR) coating for one wavelength and an AR for another wavelength, an AR for one wavelength and a high reflector (HR) for another wavelength, or an HR for one wavelength and an HR for another wavelength.

In an embodiment of the present invention, the nonlinear optical device 30 has a first surface (i.e., optical facet) 30a on an end of the nonlinear optical device 30 that receives light from the laser medium 12 and a second surface (i.e., optical facet) 30b on a side of the nonlinear optical device 30 that outputs light. In an embodiment of the present invention, the first surface 30a may be an AR at the intracavity IR wavelength and couples the intracavity IR light into the nonlinear optical device 30. In an embodiment of the present invention, the first surface 30a of the nonlinear optical device 30 may be an AR at the wavelength of the nonlinear optical device 30 (e.g., at the frequency doubled wavelength). In an embodiment of the present invention, the first surface 30a of the nonlinear optical device 30 may be an HR at the wavelength of the nonlinear optical device 30 (e.g., at the frequency doubled wavelength) to prevent nonlinear optical device 30 light (e.g., light at the frequency doubled wavelength) from being coupled into, absorbed and/or scattered by the laser medium 12.

In an embodiment of the present invention, a second surface 30b of the nonlinear optical device 30 may be coated with a material that is an AR at the intracavity IR wavelength of the resonator 24, and reduces intracavity IR laser power loss. The second surface 30b of the nonlinear optical device 30 may be an AR at the wavelength of the nonlinear optical device 30, and thereby reduces intracavity laser power loss at the intracavity nonlinear optical device 30 (e.g., SHG crystal) wavelength and/or allows the nonlinear optical device 30 light beam to exit the nonlinear optical device 30. In an embodiment of the present invention, a first surface 30a of the nonlinear optical device 30 is an AR at the wavelength band of approximately 1040-1090 nm and an HR at the wavelength band of approximately 520-545 nm, and the second surface is an AR at the wavelength band of approximately 1040-1090 nm and an AR at the wavelength band of approximately 520-545 nm.

In embodiments of the present invention, the coatings may include one or more same materials, or different materials, material systems and/or combination of materials and material systems, for example, dielectric materials. In embodiments of the present invention, the coatings may include tantalum (Ta), silicon (Si), titanium (Ti), hafnium (Hf). In embodiments of the present invention, the materials may include at least one or more oxidized versions of Ta, Si, Ti, Hf. In embodiments of the present invention, the coatings forming the AR and/or HR surfaces on the first and second surfaces 30a,30b (i.e., optical facets) of the nonlinear optical device 30 may include, for example, dielectric stacks (e.g., alternating layers) of Ta₂O₅ and SiO₂, TiO₂ and SiO₂, and/or HfO₂ and SiO₂. In embodiments of the present invention, the nonlinear optical device 30 converts an intracavity broadband IR wavelength of 1040-1090 nm or approximately 1040-1090 nm to 520-545 nm or approximately 520-545 nm via utilization of, for example, a Ta₂O₅/SiO₂ dielectric stack as an AR at 1040-1090 nm and an HR at 520-545 nm for the first surface 30a, and a Ta₂O₅/SiO₂ dielectric stack as an AR at 1040-1090 nm and an AR at 520-545 nm for the second surface 30b of the nonlinear optical device 30.

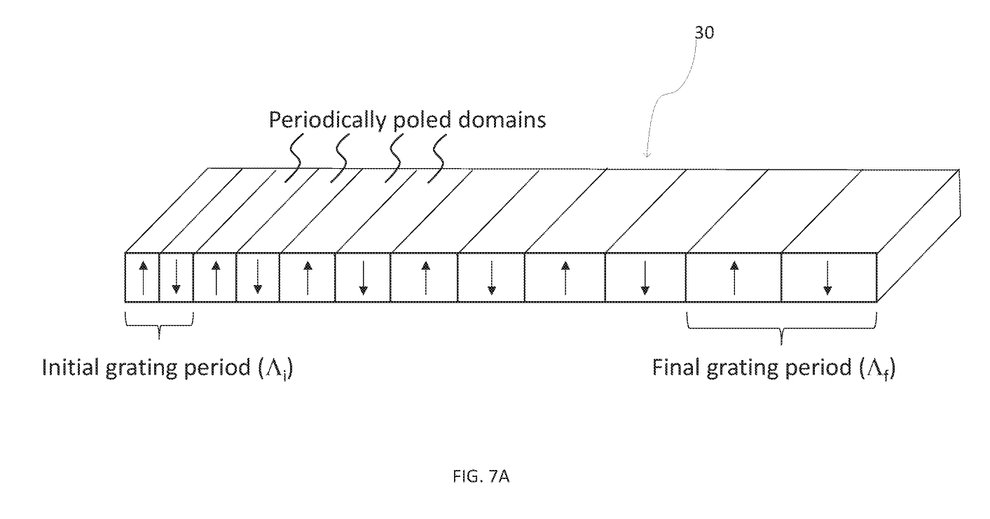

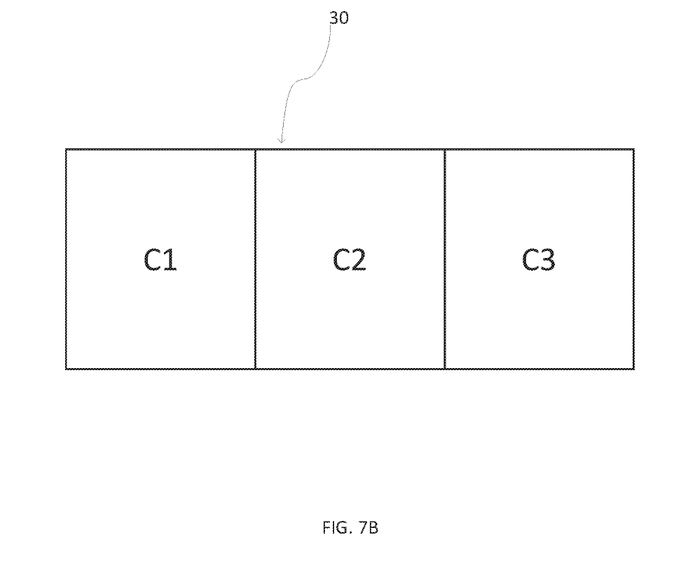

The nonlinear optical device 30 (e.g., SHG crystal) has a temperature bandwidth of between and including approximately −100 and 100 degrees Celsius with a typical operating temperature between and including approximately 40 and 50 degrees Celsius. In embodiments of the present invention, the nonlinear optical device 30 (e.g., SHG crystal) may be a periodically poled (PP) material, as shown in FIGS. 7A and 7B. A periodically poled material has periodic reversal of the domain orientation to yield a periodic reversal of the sign of the nonlinear coefficient of the nonlinear optical device 30, enabling operation over a wide wavelength range via the technique of quasi-phase matching (QPM). FIG. 7A illustrates a periodically poled nonlinear optical device 30, and the arrows shown in FIG. 7A indicate the poling direction of the poled domains. In embodiments of the present invention, the nonlinear optical device 30 may be chirped (e.g., by linearly chirping the QPM grating period across the nonlinear optical device 30 length). In an embodiment of the present invention, the nonlinear optical device 30 is a chirped PP SHG crystal, and the chirping rate (i.e., rate of change of the QPM grating period from surface 30a to surface 30b in spatial frequency space) provides an increased temperature bandwidth over which the nonlinear optical device 30 and/or a laser system and/or device 10a,10b, of the present invention, operates (e.g., approximately between and including −100 to 100 degrees Celsius).

In an embodiment of the present invention, the nonlinear optical device 30 may be periodically poled lithium niobate (PPLN). In other embodiments of the present invention the nonlinear optical device 30 may be, for example, periodically poled lithium tantalate (PPLT) and/or periodically poled potassium titanyl phosphate (PPKTP). In an embodiment of the present invention, the nonlinear optical device 30 may be chirped PPLN. In another embodiment of the present invention, the nonlinear optical device 30 may be chirped PPLT or chirped PPKTP.

As shown in FIG. 7A, an embodiment of a nonlinear optical device 30, in accordance with the present invention, may be a PPLN crystal having a length between and including approximately 1 mm and 3 mm, a linearly chirped grating (e.g., with initial and final grating periods Λᵢ and Λ_{f}, where Λᵢ and Λ_{f}, are approximately 6.392 microns and 6.867 microns, respectively, having a duty cycle of approximately 50%, and having an output beam of light that has a center wavelength of approximately between and including 524 nm and 532 nm (e.g., of 532 nm) and a FWHM spectral bandwidth of approximately 10 nm.

In an embodiment of the present invention, a nonlinear optical device 30 (e.g., an SHG crystal) is an approximately 4 mm long PPLN with a linearly chirped grating having initial and final grating periods of between and including approximately 6.392 microns and 6.867 microns, respectively, and 50% duty cycle, that outputs a beam of light having a center wavelength of 524 nm or approximately 524 nm and a FWHM spectral bandwidth of approximately 10 nm.

In another embodiment of the present invention, the PPLN crystal length may be varied between approximately and including 5 mm and 20 mm with a linearly chirped grating (e.g., initial and final grating periods of approximately 6.047 microns and 7.321 microns, respectively, and 50% duty cycle), achieving a center wavelength in the range of between and including approximately 524 nm and 532 nm, and a FWHM spectral bandwidth of approximately 30 nm.

In an embodiment of a nonlinear optical device 30 of the present invention, as shown in FIG. 7B, a nonlinear optical device 30 (e.g., a periodically poled SHG device) may include multiple regions (e.g., C1, C2, C3) having linearly chirped gratings of the same and/or different chirp rates and approximately 50% duty cycle to achieve, for example, frequency doubling, over a wide range of nonlinear optical device 30 (e.g., SHG device) wavelengths and over a wide range of temperatures.

In another embodiment of a nonlinear device 30 of the present invention, as shown in FIG. 7B, the nonlinear device 30 may include multiple regions (e.g., C1, C2, C3) having fixed QPM grating periods (e.g., Λ₁, Λ₂, Λ₃) that may be the same or different.

In an embodiment of the present invention, the nonlinear optical device 30 may be a PPLT SHG crystal that has a higher damage threshold for green-induced IR absorption (GRIIRA) compared to PPLN, and achieves a laser system and/or device 10a,10b, in accordance with the present invention, that has high-power operation (e.g., output power greater than 3.5 W).

In this embodiment of the present invention, the nonlinear optical device 30 may be a PPLT crystal of length in the range of between and including approximately 5 mm and 10 mm, and having an initial QPM chirped grating period between and including approximately 7.392 microns and 7.57 microns, and a final QPM chirped grating period between and including approximately 7.71 microns and 7.86 microns. A PPLT crystal, of approximate length 4 mm, approximate initial grating period of 7.392 microns, and approximate initial grating period of 7.86 microns, has a center wavelength of approximately 524 nm and approximate spectral bandwidth of 10 nm.

As shown in FIG. 1A, in an embodiment of the present invention an output coupler 32 may be utilized to receive the light beam exiting the nonlinear optical device 30 and outputs laser light, for example, broadband green light. In an embodiment of the present invention, the first and second surfaces 32a,32b of the output coupler 32 are coated with one or more materials or material systems that are tailored to reflect and/or transmit wavelength of light generated (e.g., generated in the resonator 24).

In an embodiment of the present invention, a coating may serve more than one purpose (e.g., dual purposes), for example, the coating may be an anti-reflector (AR) coating for one wavelength and an AR for another wavelength, an AR for one wavelength and an high reflector (HR) for another wavelength, or an HR for one wavelength and an HR for another wavelength. In an embodiment of the present invention, a first surface 32a (i.e., a side that receives light from the nonlinear optical device 30) of the output coupler 32 may be utilized as an HR at the intracavity broadband IR lasing wavelength, providing cavity-enhancement of the intracavity broadband IR power and intensity due to optical feedback between 12a and 32a, and providing high conversion efficiency of the broadband IR light in the nonlinear optical device 30 (e.g., SHG crystal) due to nonlinear optical effects (e.g., frequency doubling and sum-frequency generation) into, for example, the broadband frequency doubled light. The output coupler 32, of the present invention, receives the light output by the nonlinear optical device 30 (e.g., SHG crystal), and serves to increase the power output of the nonlinear optical device 30 (e.g., SHG crystal), and consequently, achieves a high electrical to optical (E-O) efficiency (e.g., in the range of approximately between and including 15% and 25%) of the laser system and/or device 10a (e.g., a broadband green laser system and/or device), in accordance with the present invention.

In an embodiment of the present invention, a first surface 32a of the output coupler 32 is an AR at the nonlinear optical device 30 wavelength band (e.g., the SHG wavelength band) of 520-545 nm or approximately 520-545 nm. The output coupler 32 has a second surface 32b (i.e., a surface on a side of the output coupler that transmits light) that may be an AR at the intracavity IR wavelength band of 1040-1090 nm or approximately 1040-1090 nm and an AR at the frequency-doubled wavelength of 520-545 nm or approximately 520-545 nm. In an embodiment of the present invention, outcoupling of the residual leaked IR light from the second surface 32b of the output coupler 32, in accordance with the present invention, prevents IR light from the laser resonator 24 from going back into the laser medium 12 and/or the laser resonator 24 that could destabilize the resonator.

In embodiments of the present invention, the first and second surfaces 32a,32b of the output coupler 32 are coated with one or more materials and/or material systems that are tailored to reflect and/or transmit wavelength of light generated. In embodiments of the present invention, the coatings on the output coupler 32 may include one or more same materials, different materials and/or combination of materials, for example, dielectric materials. In embodiments of the present invention, the coatings may include tantalum (Ta), silicon (Si), titanium (Ti), hafnium (Hf). In embodiments of the present invention, the materials may include at least one or more oxidized versions of Ta, Si, Ti, Hf.

In embodiments of the present invention, the coatings forming the AR and/or HR surfaces on the first and second surfaces 32a,32b (i.e., optical facets) of the output coupler 32 may include, for example, dielectric stacks (e.g., alternating layers) of Ta₂O₅ and SiO₂, TiO₂ and SiO₂, and/or HfO₂ and SiO₂. In embodiments of the present invention, the output coupler 32 transmits residual leaked IR light having a wavelength (e.g., approximately 1040-1090 nm) and the light, for example, the frequency doubled light (e.g., approximately 520-545 nm) via utilization of, for example, a Ta₂O₅ and SiO₂ dielectric stack as an HR at approximately 1040-1090 nm and an AR at approximately 520-545 nm for the first surface 32a and a Ta₂O₅ and SiO₂ dielectric stack as an AR at approximately 1040-1090 nm and an AR at approximately 520-545 nm for the second surface 32b.

In an embodiment of the present invention, an output coupler 32 is positioned in a resonator 24 before the nonlinear optical device 30 (SHG crystal) that is positioned external to the resonator 24.

In an embodiment of the present invention, the output coupler 32 may be a plano-concave output coupler, having a surface that has a radius of curvature in the range between and including approximately 100 mm and 2000 mm. In an embodiment of the present invention, the output coupler 32 is a plano-concave output coupler having a surface that has a radius of curvature of approximately 1000 mm. In an embodiment of the present invention, the output coupler 32 may have a height in the range of 0.5 mm and 5 mm, a width in the range of 0.5 mm and 5 mm, and a length in the range of 0.5 mm and 5 mm. In an embodiment of the present invention, an output coupler 32, in accordance with the present invention, has dimensions of 2 mm×2 mm×0.5 mm. In an embodiment of the present invention, a first surface 32a of the output coupler 32 having a curved surface provides a stable resonator for a laser system/device 10a,10b and or resonator 24, in accordance with the present invention.

In an embodiment of the present invention, a laser system and/or device 10a,10b, utilizes surfaces having one or more curved surfaces, for example, surface 32a of the output coupler 32, does not rely on thermal lensing to stabilize the laser system in accordance with the present invention. To the contrary, laser systems where all of the laser resonator components have flat surfaces, rely entirely on thermal lensing in the laser gain medium for its stability.

In an embodiment of the present invention, an active and/or passive Q-switch may be included in the laser resonator to generate pulses of broadband IR light having kW-level peak power and nanosecond-range pulse width (i.e., IR pulses with high intensity) that are more efficiently converted into broadband frequency doubled light in a nonlinear optical device 30, enhancing the broadband green output power of the laser system/device 10a,10b. For example, a laser resonator 24 may include a Cr:YAG crystal as a passive Q-switch for generation of high peak power IR pulses that are more efficiently frequency doubled in the nonlinear optical device 30, improving the green output power performance of the laser system/device 10a,10b.

In an embodiment of the present invention, the laser system and/or device 10a,10b is a broadband green laser system and/or device, and includes a laser gain medium 12 having Yb:CALGO and a nonlinear optical device 30 that is a PPLN crystal as a frequency doubling device. A laser system and/or device 10a, in accordance with the present invention: has a center wavelength of 530 nm or approximately 530 nm; has a spectral bandwidth of approximately between and including 5 nm and 10 nm; has a high output beam polarization ratio that is approximately greater than or equal to 100:1; has a high electrical-to-optical (E-O) efficiency of approximately between and including 15% and 25%; and/or achieves high output power of approximately 3.0 W. In an embodiment of the present invention, a diode-pumped solid-state laser system and/or device 10a,10b, in accordance with the present invention, may be operated in a continuous-wave, quasi-continuous-wave mode or pulsed mode.

In another embodiment of the present invention, the laser system and/or device 10a,10b is a broadband green laser system and/or device, and includes a laser gain medium 12 having Yb:CALGO and a nonlinear optical device 30 that is a PPLT crystal as a frequency doubling device. A laser system and/or device 10a in accordance with the present invention: has a center wavelength of 525 nm or approximately 525 nm; has a spectral bandwidth of approximately between and including 5 nm and 10 nm; has a high output beam polarization ratio that is approximately greater than or equal to 100:1; has a high electrical-to-optical (E-O) efficiency of approximately between and including 15% and 25%; and/or achieves high output power of approximately 12 W. In an embodiment of the present invention, a diode-pumped solid-state laser system and/or device 10a,10b, in accordance with the present invention, may be operated in a continuous-wave, quasi-continuous-wave or pulsed mode.

In an embodiment of the present invention, a laser system/device 10a,10b, in accordance with the present invention, may have a length in the range of approximately between and including 50 mm and 100 mm, a width in the range of approximately between and including 25 mm and 50 mm, a height in the range of approximately between and including 25 mm and 50 mm. In an embodiment of the present invention, a laser system/device 10a,10b has a length of approximately 60 mm, a width of approximately 30 mm, and a height of approximately 30 mm. It would be understood by one of ordinary skill in the art that the height, width, and length labels for the dimensions of components of the laser system and/or device system 10a,10b, in accordance with the present invention, may be interchanged (e.g., a dimension labeled as a width may be relabeled as the height for a particular component).

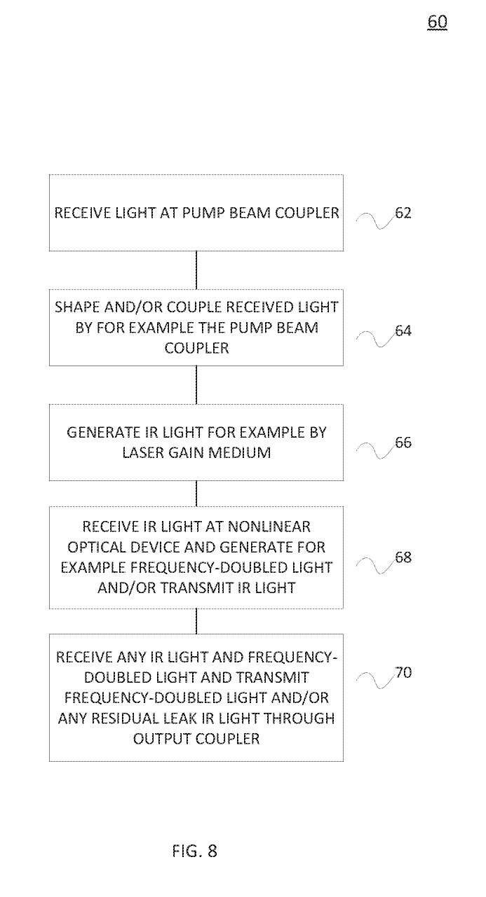

As shown in FIG. 8, a method 60 of lasing, in accordance with the present invention, includes, in step 62, receiving light at a pump beam coupler 18. In an embodiment of the present invention, the light may come from a pump source 14 (e.g., light source), for example, a laser diode. In step 64, the pump beam coupler 18 shapes and/or couples light received from the pump source 14. In step 66 the laser medium 12 (e.g., laser gain medium) receives light transmitted or emitted from the pump beam coupler 18 and generates infrared (IR) light. In step 68, the nonlinear optical device 30 (e.g., frequency doubling device) receives the IR light, from, for example, the laser medium 12, and nonlinearly converts the received IR light, for example, doubles the frequency of the IR light (e.g., doubles the frequency from approximately 1064 nm to approximately 532 nm). In an embodiment of the present invention, in step 68, the nonlinear optical device 30 may allow IR light from, for example, the laser medium 12, to pass through the nonlinear optical device 30. In an embodiment of the present invention, in step 70, the output coupler 32 receives the IR light from, for example the laser medium 12 and/or the nonlinearly converted light (e.g., the frequency doubled light) from the nonlinear optical device 30, reflects any received IR light back into the laser resonator 24, transmits the frequency doubled light received and/or transmits any residual IR leaked from the laser resonator 24. In an embodiment of the present invention, step 70 may be performed before step 68 when the nonlinear optical device 30 is external to a laser resonator 24.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

Some non-limiting examples are provided below.

Example 1 includes a laser, comprising: a laser gain medium; and a second-harmonic generator (SHG) coupled with the laser gain medium.

Example 2 includes a laser of example 1, wherein the laser gain medium comprises a Yb:CALGO crystal.

Example 3 includes a laser of example 1, wherein the laser gain medium comprises a Yb:YAG crystal.

Example 4 includes a laser of example 1, wherein the laser gain medium comprises a Yb:KYW crystal.

Example 5 includes a laser of example 1, wherein the laser gain medium has a broad fluorescence bandwidth.

Example 6 includes a laser of example 1, wherein the SHG comprises a SHG crystal.

Example 7 includes a laser of example 6, wherein the SHG crystal comprises one of the following: a periodically poled lithium niobate (PPLN) crystal, a periodically poled lithium tantalate (PPLT) crystal, or a periodically poled potassium titanyl phosphate (PPKTP) crystal.

Example 8 includes a laser of example 6, wherein broadband IR light is frequency-doubled in the SHG crystal.

Example 9 includes a laser of example 6, wherein broadband IR light is sum-frequency generated in the SHG crystal.

Example 10 includes a laser of example 6, wherein the SHG crystal is chirped.

Example 11 includes a laser of example 10, wherein the SHG crystal comprises a chirped PPLN crystal.

Example 12 includes a laser of example 11, wherein a length of the chirped PPLN crystal is approximately 4 mm with a linearly chirped grating.

Example 13 includes a laser of example 12, wherein an initial grating period is approximately 6.392 microns and a final grating period is approximately 6.867 microns and approximately 50% duty cycle.

Example 14 includes a laser of example 13, wherein a center wavelength is approximately between and including 524 nm and 532 nm and a full-width at half maximum (FWHM) spectral bandwidth is approximately between and including 5 nm and 10 nm.

Example 15 includes a laser of example 14, wherein the center wavelength is between approximately and including 524 nm to 532 nm and the FWHM spectral bandwidth is approximately 10 nm.

Example 16 includes a laser of example 11, wherein a length of the SHG crystal is between approximately and including 5 and 10 mm.

Example 17 includes a laser of example 16, wherein an initial grating period is approximately 6.047 microns and a final grating period is approximately 7.321 microns and 50% duty cycle.

Example 18 includes a laser of example 10, wherein the SHG crystal comprises a chirped PPLT crystal.

Example 19 includes a laser of example 18, wherein a length of the chirped PPLT crystal is between and including approximately 5 mm and 10 mm.

Example 20 includes a laser of example 19, wherein an initial grating period is approximately 7.392 microns and a final grating period is approximately 7.86 microns and approximately 50% duty cycle.

Example 21 includes a laser of example 20, wherein a center wavelength is approximately between and including 520 nm and 530 nm and a FWHM spectral bandwidth is approximately between and including 5 nm and 10 nm.

Example 22 includes a laser of example 21, wherein a center wavelength is between approximately and including 524 to 532 nm and a FWHM spectral bandwidth is approximately 310 nm.

Example 23 includes a laser of example 10, wherein the SHG crystal comprises a chirped PPKTP crystal.

Example 24 includes a laser of example 1, wherein a coating of a first surface of the laser gain medium comprises an anti-reflector (AR) coating.

Example 25 includes a laser of example 1, wherein a coating of a first surface of the laser gain medium comprises a high-reflector (HR) coating.

Example 26 includes a laser of example 1, wherein a coating of a second surface of the laser gain medium comprises an AR coating.

Example 27 includes a laser of example 1, wherein a coating of a second surface of the laser gain medium comprises an HR coating.

Example 28 includes a laser of example 1, wherein a coating of a first surface of the SHG is an AR coating.

Example 29 includes a laser of example 1, wherein a coating of a first surface of the SHG is an HR coating.

Example 30 includes a laser of example 1, wherein a coating of a second surface of the SHG is an AR coating.

Example 31 includes a laser of example 1, wherein a coating of a second surface of the SHG is an HR coating.

Example 32 includes a laser of example 10, wherein the SHG crystal is chirped by linearly chirping the grating period across the SHG length.

Example 33 includes a laser of example 1, further comprising:

an optical pump source;

a pump-beam coupler (PBC) coupled with the optical pump source and the laser gain medium; and

an optical coupler coupled with the second-harmonic generator.

Example 34 includes a laser of example 33, wherein a coating of a first surface of the optical coupler comprises an AR coating.

Example 35 includes a laser of example 33, wherein a coating of a first surface of the optical coupler comprises an HR coating.

Example 36 includes a laser of example 33, wherein a coating of a second surface of the optical coupler comprises an AR coating.

Example 37 includes a laser of example 33, wherein a coating of a second surface of the optical coupler comprises an HR coating.

Example 38 includes a laser of example 33, wherein the optical pump source comprises one of the following: a single emitter, a laser diode bar, or a laser diode stack.

Example 39 includes a laser of example 33, wherein the optical pump source outputs a spectrum compatible with the laser gain medium.

Example 40 includes a laser of example 39, wherein the optical pump source has a center wavelength between and including approximately 971 nm to 980 nm.

Example 41 includes a laser of example 33, wherein the PBC comprises at least one refractive optical element.

Example 42 includes a laser of example 33, wherein the PBC comprises at least one diffractive optical element.

Example 43 includes a laser of example 33, wherein the PBC comprises at least one fast-axis lens.

Example 44 includes a laser of example 33, wherein the PBC comprises at least one slow-axis lens.

Example 45 includes a laser of example 33, further comprising a heatsink coupled with the laser gain medium.

Example 46 includes a laser of example 45, wherein the laser gain medium comprises a metallized surface, and wherein the heatsink is soldered to the metallized surface.

Example 47 includes a laser of example 45, wherein the metallized surface comprises one of Ti/Pt/Au, Cr/Ni/Au or NiAu.

Example 48 includes a laser of example 45, wherein an epoxy couples the laser gain medium with the heat sink.

Example 49 includes a laser of example 46, wherein solder comprises one of InSn solder, AuSn solder, In solder, InAg solder or SAC solder.

Example 50 includes a laser of example 45, wherein a height of the laser gain medium is between approximately and including 0.5 mm to 2 mm.

Example 51 includes a laser of example 33, wherein the output coupler comprises a plano-concave output coupler.

Example 52 includes a laser of example 1, further comprising:

an optical pump source;

a PBC coupled with the optical pump source and the laser gain medium; and

an output coupler coupled with the laser gain medium; and

a laser output beam shaper coupled with the output coupler and the second-harmonic generator.

Example 53 includes a diode-pumped solid-state laser (DPSSL), comprising:

an optical pump source;

a PBC coupled with the optical pump source;

a laser gain medium coupled with the PBC;

a second-harmonic generator coupled with the laser gain medium; and

an optical coupler coupled with the second-harmonic generator.

Example 54 includes a DPSSL of example 53, wherein the laser gain medium comprises a Yb:CALGO crystal.

Example 55 includes a DPSSL of example 54, wherein the Yb:CALGO crystal has a fluorescence bandwidth of approximately 80 nm.

Example 56 includes a DPSSL of example 54, wherein the Yb:CALGO crystal length is approximately 5 mm, with a Yb³⁺ doping level of approximately 3 at. % doped.

Example 57 includes a DPSSL of example 54, wherein the Yb:CALGO crystal length is approximately 1 mm to approximately 15 mm, with a Yb³⁺ doping level is between and including approximately 0.2 at. % doped to 10 at. % doped.

Example 58 includes a DPSSL of example 54, wherein the Yb:CALGO crystal is doped.

Example 59 includes a DPSSL of example 58, wherein doping of the Yb:CALGO crystal comprises gradient doping.

Example 60 includes a DPSSL of example 54, wherein the Yb:CALGO crystal is segmented.

Example 61 includes a DPSSL of example 53, wherein the gain medium comprises a grazing-incidence crystal.

Example 62 includes a DPSSL of example 61, wherein the grazing-incidence crystal comprises a doped thin disk.

Example 63 includes a DPSSL of example 62, wherein the doped thin disk is approximately 0.5-mm-thick, 10-at. %-doped with an undoped CALGO bonded to the disk.

Example 64 includes a DPSSL of example 62, wherein the doped thin disk is between and including approximately 0.1 mm to 0.75 mm, and wherein the doping level is between and including approximately 7.5 to 15 at. %.

Example 65 includes a DPSSL of example 53, wherein a coating of a first surface of the laser gain medium comprises an anti-reflector (AR) coating and a coating of a second surface of the laser gain medium comprises a high-reflector (HR) coating.

Example 66 includes a DPSSL of example 53, wherein a coating of a first surface of the laser gain medium comprises an HR coating and a coating of a second surface of the laser gain medium comprises an AR coating.

Example 67 includes a DPSSL of example 53, wherein a coating of a first surface of the SHG and a second surface of the SHG comprise an AR coating.

Example 68 includes a DPSSL of example 53, wherein a coating of a first surface of the SHG comprises an HR coating and a coating of a second surface of the SHG comprises an AR coating.

Example 69 includes a DPSSL of example 53, wherein a coating of a first surface of the optical coupler comprises an HR coating and a coating of a second surface of the optical coupler comprises an AR coating.

Example 70 includes a DPSSL of example 53, wherein a coating of a first surface of the laser gain medium and a first surface of optical coupler comprises an HR coating, and a coating of a second surface of the laser gain medium, a coating of a first surface and a second surface of the SHG, and a second surface of the optical coupler comprises an AR coating.

Example 71 includes a diode-pumped solid-state laser (DPSSL), comprising:

an optical pump source;

a PBC coupled with the optical pump source;

a laser gain medium coupled with the PBC;

an optical coupler coupled with the laser gain medium; and

a second-harmonic generator coupled with the output coupler.

Example 72 includes a DPSSL of example 71, further comprising a laser output beam shaper coupled with the output coupler and the second-harmonic generator.

Example 73 includes a solid state laser system, comprising: a laser medium, wherein said laser medium comprises Yb:CALGO; and a frequency doubler device positioned in an optical path after the laser medium.

Example 74 includes the laser system of claim 73, wherein the frequency doubler is at least one of a PPLN and a PPLT.

Example 75 includes the laser system of claim 73, wherein the at least one of a PPLN and a PPLT is chirped.

Example 76 includes the laser system of claim 73, wherein the laser medium has a doping of Yb³⁺ in a range between and including approximately 1 at. % doped to 10 at. % doped.

Example 77 includes the laser system of claim 76, wherein the laser medium has a doping of Yb³⁺ of approximately 3 at. % doped.

Example 78 includes the laser system of claim 73, wherein the laser medium has a length of between and including approximately 1 mm and 15 mm.

Example 79 includes the laser system of claim 73, wherein the laser medium has a length of approximately 5 mm.

Example 80 includes the laser system of claim 73, the laser medium has a gradient doping along a length of the laser medium.

Example 81 includes the laser system of claim 80, wherein the gradient doping of the laser medium comprises a dopant concentration in a range between and including approximately 0.1 at. % and 1.0 at. % at a first face of the laser medium and gradually increases to a dopant concentration in a range of between and including approximately 2 at. % and 6 at. % toward the center of the laser medium.

Example 82 includes the laser system of claim 73, wherein the frequency doubler is a periodically poled SHG having linearly chirped gratings of at least one of same and/or different chirp rates.

Example 83 includes the laser system of claim 73, further comprising a pump source optically positioned before the laser gain medium.

Example 84 includes the laser system of claim 83, further comprising a pump beam coupler optically positioned after the pump source and before the laser medium.

Example 85 includes the laser system of claim 83, wherein the pump source has an output power in a range between and including approximately 10 W and 100 W.

Example 86 includes the laser system of claim 85, wherein the output power of the pump source is 40 W.

Example 87 includes the laser system of claim 84, wherein the pump beam coupler comprises a plano-convex cylindrical lens.

Example 88 includes the laser system of claim 83, wherein the pump source has an output wavelength of approximately 980 nm.

Example 89 includes a state laser system, comprising: a laser gain medium comprising Yb:CALGO, having a first surface and a second surface, wherein the first surface is an AR at a first wavelength and an HR at a second wavelength; a frequency doubler device positioned in an optical path after the laser medium, wherein the frequency doubler positioned after the laser gain medium.

Example 90 includes the laser system of claim 89, further comprising a pump source that emits light at the first wavelength.

Example 91 includes a laser system, comprising: a pump source comprising Yb:CALGO that pumps light at a pump wavelength; a laser gain medium positioned after the pump source and having a first surface and a second surface, wherein the lasing medium generates light at an intracavity lasing wavelength, and wherein the first surface is an AR at the pump wavelength, and wherein the second surface is an AR at the intracavity lasing wavelength and at least one of an AR and HR at the pump wavelength.

Example 92 includes the laser system of claim 90, wherein the pump source wavelength is approximately 980 nm.

What is claimed is:

1. A solid state laser system, comprising:
a laser medium, wherein said laser medium comprises Yb:CALGO, wherein the laser medium has a length that is greater than or equal to 1 mm and less than 3 mm; and
a frequency doubler device positioned in an optical path after the laser medium.

2. The laser system of claim 1, wherein the frequency doubler is at least one of a PPLN and a PPLT.

3. The laser system of claim 1, wherein the at least one of a PPLN and a PPLT is chirped.

4. The laser medium of claim 1, wherein the laser medium has a doping of Yb³⁺ in a range between and including approximately 1 at. % doped to 10 at. % doped.

5. The laser medium of claim 4, wherein the laser medium has a doping of Yb³⁺ of approximately 3 at. % doped.

6. (canceled)

7. The laser system of claim 1, wherein the laser medium has a length of approximately 5 mm.

8. The laser system of claim 1, the laser medium has a gradient doping along a length of the laser medium.

9. The laser system of claim 8, wherein the gradient doping of the laser medium comprises a dopant concentration in a range between and including approximately 0.1 at. % and 1.0 at. % at a first face of the laser medium and gradually increases to a dopant concentration in a range of between and including approximately 2 at. % and 6 at. % toward the center of the laser medium.

10. The laser system of claim 1, wherein the frequency doubler is a periodically poled SHG having linearly chirped gratings of at least one of same and/or different chirp rates.

11. The laser system of claim 1, further comprising a pump source optically positioned before the laser gain medium.

12. The laser system of claim 11, further comprising a pump beam coupler optically positioned after the pump source and before the laser medium.

13. The laser system of claim 11, wherein the pump source has an output wavelength of approximately 980 nm.

14. The laser system of claim 13, wherein the output power of the pump source is 4 W.

15. The laser system of claim 12, wherein the pump beam coupler comprises a plano-convex cylindrical lens.

16. The laser system of claim 11, wherein the pump source has an output wavelength of approximately 980 nm.

17. A solid state laser system, comprising:
a laser gain medium comprising Yb:CALGO, having a first surface and a second surface, wherein the first surface is an AR at a first wavelength and an HR at a second wavelength;
a frequency doubler device positioned in an optical path after the laser medium, wherein the frequency doubler positioned after the laser gain medium.

18. The laser system of claim 17, further comprising a pump source that emits light at the first wavelength.

19. A laser system, comprising:
a pump source comprising Yb:CALGO that pumps light at a pump wavelength;
a laser gain medium positioned after the pump source and having a first surface and a second surface, wherein the lasing medium generates light at an intracavity lasing wavelength, and wherein the first surface is an AR at the pump wavelength, and wherein the second surface is an AR at the intracavity lasing wavelength and at least one of an AR and HR at the pump wavelength.

20. The laser system of claim 19, wherein the pump source wavelength is approximately 980 nm.

21. A solid state laser system, comprising:
a laser medium, wherein said laser medium comprises Yb:CALGO, and wherein the laser medium has a length that is greater than 3 mm and less than 4 mm; and
a frequency doubler device positioned in an optical path after the laser medium.

22. A solid state laser system, comprising:
a laser medium, wherein said laser medium comprises Yb:CALGO, and wherein the laser medium has a length that is greater than 4 mm and less than or equal to 15 mm; and
a frequency doubler device positioned in an optical path after the laser medium.

23. A solid state laser system, comprising:
a laser medium, wherein said laser medium comprises Yb:CALGO, and wherein the laser medium has a length that is greater than or equal to 1 mm and less than 2.5 mm; and
a frequency doubler device positioned in an optical path after the laser medium.

24. A solid state laser system, comprising:
a laser medium, wherein said laser medium comprises Yb:CALGO, and wherein the laser medium has a length that is greater than 2.5 mm and less than 3 mm; and
a frequency doubler device positioned in an optical path after the laser medium.

25. A solid state laser system, comprising:
a laser medium, wherein said laser medium comprises Yb:CALGO, and, wherein the laser medium has a doping of Yb³⁺ that is greater than or equal to 1 at. % doped and less than 2 at. % doped; and
a frequency doubler device positioned in an optical path after the laser medium.

26. A solid state laser system, comprising:
a laser medium, wherein said laser medium comprises Yb:CALGO, and, wherein the laser medium has a doping of Yb3+ that is greater than 2 at. % doped and less than or equal to 10 at. % doped; and
a frequency doubler device positioned in an optical path after the laser medium.

27. A solid state laser system, comprising:
a laser medium, wherein said laser medium comprises Yb:CALGO, and, wherein the laser medium has a doping of Yb3+ that is greater than or equal to 0.2 at. % doped and less than 2 at. % doped; and
a frequency doubler device positioned in an optical path after the laser medium.

28. A continuous wave solid state laser system, comprising:
a laser medium, wherein said laser medium comprises Yb:CALGO, and outputs a lasing continuous wave of electromagnetic radiation; and
a frequency doubler device positioned in an optical path after the laser medium that receives said lasing continuous wave of electromagnetic radiation.
